(19) United States
(12) Patent Application Publication
(10) Pub. No.: US 2016/0162658 A1
(43) Pub. Date: Jun. 9, 2016

(54) System and Method for Generating a Prescription Information Output

(71) Applicant: Flora Ndum, Palm Coast, FL (US)

(72) Inventor: Flora Ndum, Palm Coast, FL (US)

(21) Appl. No.: 14/957,694

(22) Filed: Dec. 3, 2015

Related U.S. Application Data
(60) Provisional application No. 62/086,768, filed on Dec. 3, 2014.

(51) Int. Cl. G06F 19/00; G06F 17/30

(52) U.S. Cl. CPC G06F 19/3456; G06F 17/30979

(57) ABSTRACT

A system and method for generating a prescription information output. The present system enables healthcare professionals and patients to keep track of the medications consumed by the patient. The present invention is a method of receiving information from a patient's prescriptions, retrieving a picture of the prescribed medication, and arranging the picture and other information into a chart. The chart is arranged by an administration time selection that is made based on the prescribed dosage. The chart generated by the present system can be attached to multi-medication bubble packs and used to verify medicine dispensed to patients.

### CROSS REFERENCE TO RELATED APPLICATIONS

This application claims the benefit of U.S. Provisional Application No. 62/086,768 filed on Dec. 3, 2014. The above identified patent application is herein incorporated by reference in its entirety to provide continuity of disclosure.

### BACKGROUND OF THE INVENTION

The present invention relates to the generation of a prescription information output. More specifically, the present invention relates to arranging prescription information into a chart.

Many assisted living facilities, nursing homes, and group homes administer a variety of medications to patients on a daily basis. However, it can be quite difficult to keep track of these various medications. If medication consumption is not properly monitored it can lead to numerous problems, such as missed treatments, overdose, toxic combinations of medications, and other serious issues.

Some individuals administering medications may choose to write a list of medications onto a piece of paper, but this can be tedious and time consuming. Further, these individuals may write down the medications erroneously or lose track of the paper with the medications listed thereon. Therefore, there exists a need for a method of arranging prescription information where medication information is retrieved directly from a database and organized based on the time the medication should be administered.

### SUMMARY OF THE INVENTION

In view of the foregoing disadvantages inherent in the known types of methods for organizing medical information now present in the prior art, the present invention provides a method for arranging prescription information wherein the medications are ultimately segregated according to administration time. The present method comprises the steps of first receiving a National Drug Code (NDC) number and retrieving a medication name from a stored database that corresponds to the NDC number.

In the following steps, a medication strength and dosage is received. Next, an administration time selection associated with each dosage is received. Thereafter, a picture corresponding to the NDC number and medication strength is retrieved from the stored database. Finally, the picture, medication name, and medication strength are arranged into a chart based on the corresponding administration time associated with the dosage received and the chart is displayed.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart illustrating an embodiment of a method for arranging prescription information.

FIG. 2 shows an embodiment of a chart generated by the present system.

### DETAILED DESCRIPTION OF THE INVENTION

Reference is made herein to the attached drawings. Like reference numerals are used throughout the drawings to depict like or similar elements of the method for arranging prescription information. For the purposes of presenting a brief and clear description of the present invention, the preferred embodiment will be discussed as used for organizing multiple medications by administration time. The figures are intended for representative purposes only and should not be considered to be limiting in any respect.

As used herein, “processor” refers to one or more devices, circuits, and/or cores configured to process data, such as a set of steps according to a computer program. Unless stated otherwise, a component such as a processor or interface described as being configured to perform a task includes both components temporarily configured to perform a task at a specified time and components manufactured to perform a task. As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals. Unless stated otherwise, a “terminal” refers to a desktop computer, a smartphone, or any other similar mobile device. The terminal houses the processor, the logic, and a memory.

The present invention is a system and method for generating a prescription information output. The purpose of the present invention is to increase care facility efficiency and patient compliance. The present invention reduces the amount of time needed to create labels for multi-medication packages and provides individuals that administer medication with pictures of the medications in a chart that clearly depicts when the medications should be taken, thereby increasing treatment compliance.

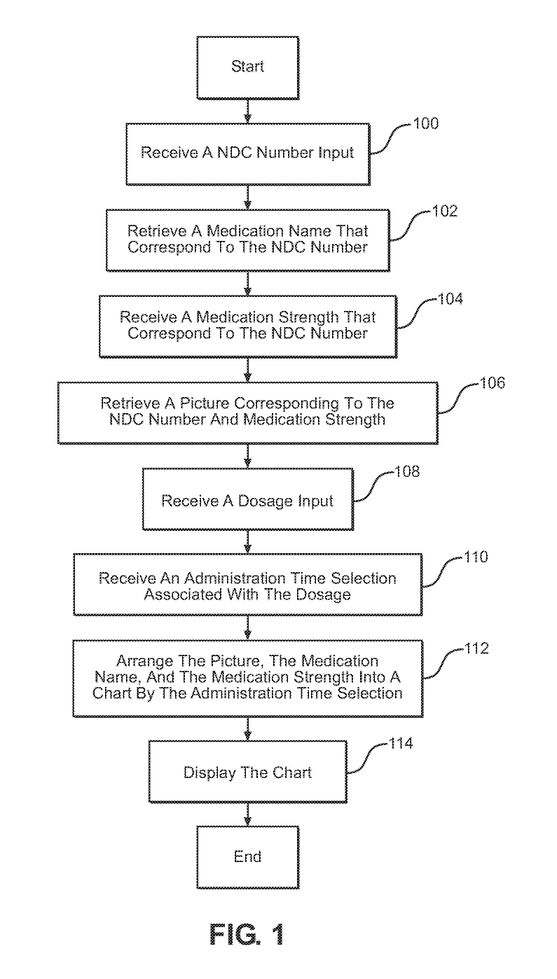

Referring now to FIG. 1, there is shown a flowchart illustrating an embodiment of a method for generating a prescription information output. At 100, a user enters a NDC number on an input of a terminal. For example, the input of the terminal could be a keyboard wherein the user types the NDC number. The logic then receives the NDC number and queries a database to retrieve the medication name corresponding to the NDC number. The database is connected to the logic via a connection medium. The connection medium includes a wired or wireless connection to the database via a telecommunications network, e.g., the Internet, or via a communications protocol, e.g. Bluetooth, that is not network-based.

The NDC number is a unique, three-segment number that is a universal identifier for drug products maintained by the U.S. Food and Drug Administration (FDA). At 102, after the database is queried, a medication name that corresponds to the NDC number is retrieved from the database and transmitted via the connection medium to the logic. For example, if the patient is prescribed NDC number 10202-416-78, the medication name retrieved is Aspirin. The medication name may be the proprietary name used for branding or the generic active ingredient. The database contains the NDC numbers and corresponding medication names from the NDC Directory that is published and updated daily by the FDA.

At 104, the logic queries the database to additionally retrieve a medication strength corresponding to the NDC number. In addition to corresponding to the name of a type of medication, the NDC number also corresponds to a dosage for the type of medication. For example, Aspirin is available in both an 81 mg tablet and a 325 mg tablet. NDC number 10202-416-78 corresponds to the 325 mg tablet. Therefore, if the database is queried with NDC number 10202-416-78, then the medication strength that will be returned is 325 mg.

At 106, the logic further queries the database to additionally retrieve a picture corresponding to the NDC. For example, the picture corresponding to NDC number 10202-416-78 will be a round white pill. In various embodiments, the picture will show a first side and a second side of the medication providing for more efficient identification. This picture is then transmitted from the database to the logic.

At 108, the logic receives a dosage entered by the user on an input of the terminal. The dosage is the prescribed amount of medication to take. It can also be the prescribed interval at which the medication is to be taken. For example, a medication might be prescribed as “two pills daily” or “one pill before bed.”

At 110, the logic receives an administration time selection associated with the dosage entered by the user on an input of the terminal. An administration time selection can be “morning,” “noon,” “evening,” or “bedtime.” The user makes this selection by choosing an administration time that corresponds with the dosage received. For example, if the prescription requires two pills after waking, the administration time selection will be “morning.” If the prescription requires two pills daily, the user can select any administration time that is appropriate.

At 112, the processor arranges the picture, medication name, and medication strength into a chart based on the corresponding administration time associated with the dosage received. For example, if the patient is prescribed one tablet of NDC number 10202-416-78 before breakfast, a picture of a white round pill, the name Aspirin, and the strength 325 mg will be placed into a column entitled “Morning.”

At 114, the processor displays the chart. In the depicted embodiment, the chart is displayed on the screen of an electronic device for a user to view. In various embodiments, the user may then print the chart onto copy paper or adhesive labels.

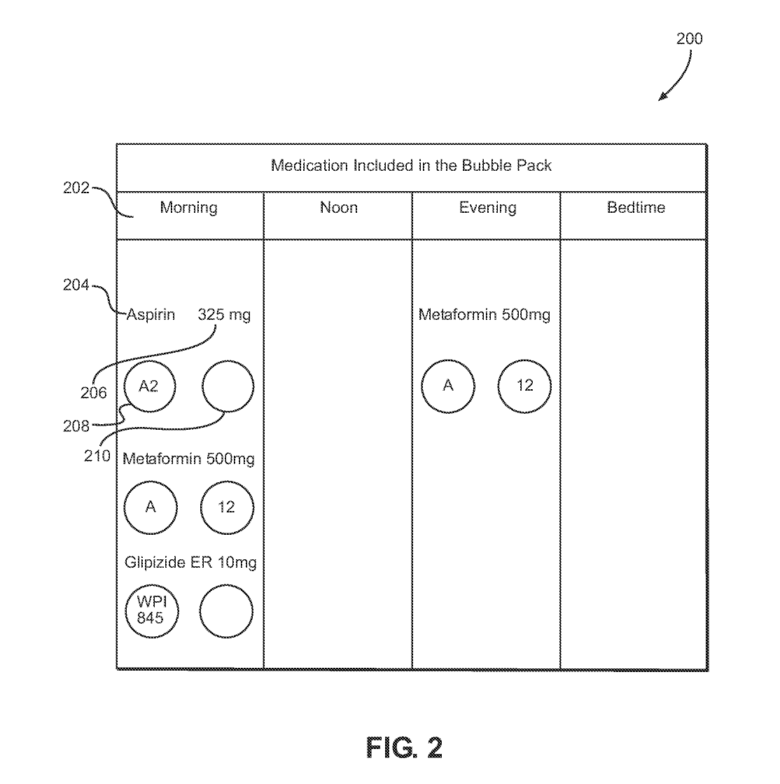

Referring now to FIG. 2, there is shown one embodiment of a chart displayed. In the depicted embodiment, each column of the chart 200 corresponds to an administration time 202, such as “Morning,” “Noon,” “Evening,” and “Bedtime.” Under each administration time 202, the medication name 204 is listed with the medication strength 206. Below that information, in the depicted embodiment, there is shown a picture of the medication. In the depicted embodiment, the picture shows both a first side 208 of the medication and a second side 210 of the medication. Multiple medication names 204 with accompanying strengths 206 and pictures can be listed in the depicted chart 200. This allows for greater prescription organization and patient treatment compliance.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method for retrieving and arranging prescription information, comprising:
receiving a NDC number;
retrieving a medication name that corresponds to the NDC number;
retrieving a medication strength that corresponds to the NDC number;
retrieving a picture corresponding to the NDC number;
receiving a dosage;
receiving an administration time selection associated with the dosage;
arranging the picture, the medication name, and the medication strength into a chart by the administration time selection; and
displaying the chart.

2) A computer system comprising:
a processor;
a non-transitory computer readable medium operatively connected to the processor;
a logic stored in the non-transitory computer readable medium that, when executed by the processor, causes the computer system to perform a method, the method comprising the steps of:
receiving a NDC number input;
retrieving a medication name that corresponds to the NDC number;
retrieving a medication strength that corresponds to the NDC number;
retrieving a picture corresponding to the NDC number;
receiving a dosage;
receiving an administration time selection associated with the dosage;
arranging the picture, the medication name, and the medication strength into a chart by the administration time selection; and
displaying the chart.

3) The method of claim 2, wherein the medication name is retrieved from a database connected to the logic.

4) The method of claim 2, wherein the medication strength is retrieved from a database connected to the logic.

5) The method of claim 2, wherein the picture is retrieved from a database connected to the logic.

6) A non-transitory computer readable medium that, when executed by a processor of a computer system, causes the computer system to perform a method, the method comprising the steps of:
receiving a NDC number input;
retrieving a medication name that corresponds to the NDC number;
retrieving a medication strength that corresponds to the NDC number;
retrieving a picture corresponding to the NDC number;
receiving a dosage;
receiving an administration time selection associated with the dosage;
arranging the picture, the medication name, and the medication strength into a chart by the administration time selection; and
displaying the chart.

7) The method of claim 6, wherein the medication name is retrieved from a database connected to the logic.

8) The method of claim 6, wherein the medication strength is retrieved from a database connected to the logic.

9) The method of claim 6, wherein the picture is retrieved from a database connected to the logic.
